(19) United States
(12) Patent Application Publication
(10) Pub. No.: US 2017/0228735 A1
(43) Pub. Date: Aug. 10, 2017

(54) FRAUD PREVENTION SECURITY SYSTEM

(71) Applicant: SYNEXXUS, INC., Arlington, VA (US)

(72) Inventor: Gregory Emil Glaros, McLean, VA (US)

(21) Appl. No.: 15/015,775

(22) Filed: Feb. 4, 2016

(51) Int. Cl. G06Q 20/40; G06Q 20/34

(52) U.S. Cl. CPC G06Q 20/4016; G06Q 20/40145; G06Q 20/34

(57) ABSTRACT

Disclosed herein are system, method, and computer program product embodiments for credit card fraud prevention. An embodiment operates by a credit card terminal capturing an interaction of a credit card with the credit card terminal and reading data stored on the credit card. The credit card terminal then transmits the data to a controller. Upon receipt of the data by the controller, the controller transmits an activation signal to a camera to capture media of a user who interacted the credit card with the credit card terminal. Once the media is captured, the controller transmits both the captured media and the data to a financial institution for security measures. Then, a message is received from the financial institution regarding the security measures, wherein the type of the message either authorizes the transaction or takes appropriate action regarding the transaction.

### FIELD

Embodiments included herein generally relate to utilizing, security systems to prevent fraudulent activity. More particularly, embodiments relate to utilizing security systems to prevent and capture the fraudulent activity to report to the associated user and law enforcement authorities.

### BACKGROUND

When, users experience fraudulent activity on their credit card (for example), the users may desire information from their financial institution regarding the fraudulent activity. For example, the users may wish to know the specifics of the fraudulent activity —what the transaction was, where the transaction occurred, the fraudulent user who completed the transaction, how the fraudulent user retrieved the credit card information, as well as any other characteristics regarding the fraudulent activity.

Financial institutions, however, normally cannot give the user associated with the credit card all the fraudulent activity information they desire. Specifically, the financial institution cannot identify the user who performed the fraudulent activity. Thus, what is needed is a way to capture the fraudulent activity information to report to the user and the law enforcement authorities.

### SUMMARY

An embodiment includes a system having a processor coupled to a router. A terminal is coupled to the processor and the router. The terminal accepts input from a card associated with an authorized user. The system also includes a camera located proximate to the terminal. The camera captures media of a person located proximate to the terminal. Further, the system includes an authentication module coupled to the processor and the router via a network. The authentication module comprises a facial recognition module. The media is transferred to the authentication module. The authentication module uses the facial recognition module to determine if the person is the authorized user.

In another embodiment, a method is provided for fraud prevention. The method operates by a credit card terminal capturing an interaction of a credit card with the credit card terminal and reading data stored on the credit card to authorize a transaction. The credit card terminal then transmits the data to a controller. Upon receipt of the data by the controller, the controller transmits an activation signal to a camera to capture media of a user who interacted the credit card with the credit card terminal. Once the media is captured, the controller transmits both the captured media and transactional information to a financial institution for security measures. Then, a message is received from the financial institution regarding the security measures, wherein the type of the message either authorizes the transaction or takes appropriate action regarding the transaction.

In another embodiment, a method operates by receiving captured media of a credit card user and transactional information from a controller. Next, data associated with the credit card is retrieved from the transactional information. Then, the method retrieves a profile of a user associated with the data. A comparison is made between the credit card user from the captured media and the user from the profile to determine if they are a match. Upon results of the comparison, a report and the transactional, information are transmitted to the user from the profile notifying of the result of the comparison. Then a type of a message is transmitted to the controller, wherein the type of the message either authorizes a transaction or does not authorize the transaction. Further, upon results of the comparison, the report is transmitted to law enforcement authorities.

A further embodiment includes a system having a controller processor that is operable to receive data stored on a credit card from a transaction. Upon receipt of the data, the controller sends an activation signal to a camera to capture media of a user who interacted the credit card with a credit card terminal. The controller receives the captured media and transmits the captured media and transactional information to a financial institution using a router. The controller then waits to receive a message from the financial institution regarding the transmitted captured media and the transactional information. Upon receipt of the message, the controller determines if the message type is an authorization message or a non-authorization message. Based on the type of message, the controller authorizes the transaction or takes further action regarding the transaction.

A further embodiment includes a tangible computer-readable medium having stored therein instructions for execution by one or more processors to perform a method for credit card fraud prevention. The method operates by a credit card terminal capturing an interaction of a credit card with the credit card terminal and reading data stored on the credit card to authorize a transaction. The credit card terminal then transmits the data to a controller. Upon receipt of the data by the controller, the controller transmits an activation signal to a camera to capture media of a user who interacted the credit card with the credit card terminal. Once the media is captured, the controller transmits both the captured media and transactional information to a financial institution for security measures. Then, a message is received from the financial institution regarding the security measures, wherein the type of the message either authorizes the transaction or takes appropriate action regarding the transaction.

A further embodiment includes a tangible computer-readable medium, having, stored therein instructions for execution by one or more processors to perform a method of credit card fraud prevention. The method operates by receiving captured media of a credit card user and transactional information from a controller. Next, data associated with the credit card is retrieved from the transactional information. Then, the method retrieves a profile of a user associated with the data. A comparison is made between the credit card user from the captured media and the user from the profile to determine if they are a match. Upon results of the comparison, a report and the transactional information are transmitted to the user from the profile notifying of the result of the comparison. Then a type of a message is transmitted to the controller, wherein the type of the message either authorizes a transaction or does not authorize the transaction. Further, upon results of the comparison, the report is transmitted to law enforcement authorities.

Further features and advantages of the embodiments disclosed herein, as well as the structure and operation of various embodiments, are described in detailed below with reference to the accompanying drawings. It is noted that the invention is not limited to the specific embodiments described herein. Such embodiments are presented herein for illustrative purposes only. Additional embodiments will be apparent to a person skilled in the relevant art based on the teachings contained herein.

### BRIEF DESCRIPTION OF THE DRAWINGS

The accompanying drawings are incorporated herein and form a part of the specification.

FIG. 1 illustrates a block diagram of a credit card fraud prevention system, according to an example embodiment.

FIG. 2 is a flowchart illustrating a process of capturing and preventing credit card fraud at a credit card terminal, according to an example embodiment.

FIG. 3 is a flowchart illustrating a process of capturing and preventing credit card fraud prevention at a financial institution, according to an example embodiment.

FIG. 4 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION OF THE INVENTION

Provided herein are system, method and/or computer program product embodiments, and/or combinations and sub-combinations thereof, for utilizing security systems to prevent and capture fraudulent credit card activity.

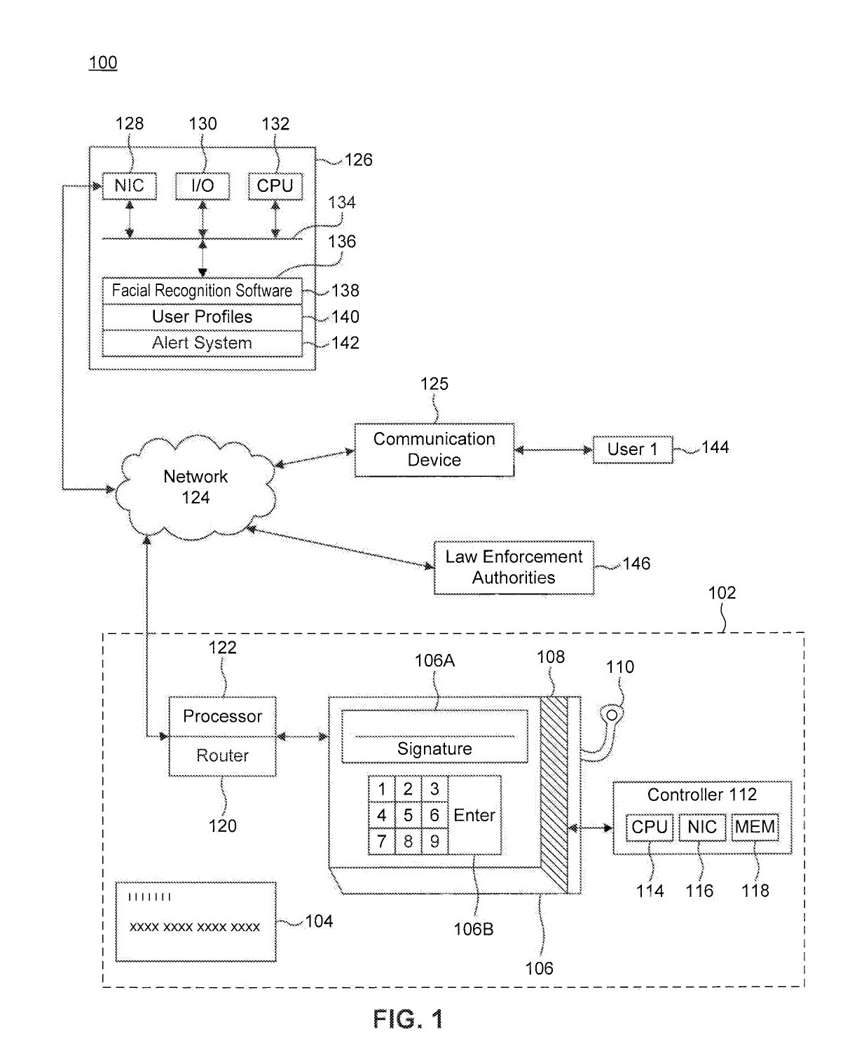

FIG.1 illustrates a credit card security system 100 for preventing and capturing fraudulent credit card activity. In an embodiment, the credit card security system 100 includes a retail store 102 communicating over a bidirectional network 124 to financial institution 126 and to user 144.

In an embodiment, the retail store 102 may be, without limitation, a grocery store, an automotive shop, a department store, a warehouse store, and/or any store where a credit card 104 interacting, with a credit card terminal 106 completes a transaction, according to example embodiments. Specifically, the credit card 104 may interact with the credit card terminal 106 by swiping the credit card 104 though the credit card terminal 106; inserting the credit card 104 into the credit card terminal 106; tapping the credit card 104 onto the credit card terminal 106; and, waving the credit card 104 over the credit card terminal 106, according to example embodiments.

The retail store 102 may include one or more of the components in the credit card security system 100, according to an embodiment. Further, the retail store 102 may include the credit card 104 and the credit card terminal 106, according to an embodiment. The credit card terminal 106 may include a digital signature display line 106A, a keypad for entering a personal identification number 106B and an interaction terminal 108 through which the credit card 104 interacts for completing a transaction, according to an embodiment.

In an embodiment, camera 110 may be attached to or proximate to credit card terminal 106. In an alternative embodiment, the camera 110 may be embedded inside of credit card terminal 106. The camera 110 may attach itself to the credit card terminal 106 in any wired or wireless manner, according to an embodiment.

In an embodiment, controller 112 may be attached to credit card terminal 106. The controller 112 may include a central processing unit (CPU) 114, a network interface card (NIC) 116 for any wireless or wired communications based on the connection to credit card terminal 106, and a memory device 118. In an alternative embodiment, controller 112 may be embedded inside of credit card terminal 106. By embedding the controller 112 inside of credit card terminal 106, credit card security system 100 may be discretely implemented and used in a manner unseen to the public eye for security purposes.

Retail store 102 may also include a router 120 and a processor 122, according to an embodiment. In conjunction, the router 120 and the processor 122 may be used to convert the digital data received by controller 112 to IP packets for transmission to financial institution 126 over network 124. This will be further explained below.

Financial institution 126 may include a network interface circuit (NIC) 128, an input/output (I/O) device 130, a central processing unit (CPU) 132, a transmission bus 134, and a memory device 136, according to an embodiment. Memory device 136 of financial institution 126 may include facial recognition software 138, user profiles database 140 and alert system 142, according to an embodiment. In an example embodiment, financial institution 126 may include but not be limited to a credit card institution or a bank.

A user 144 is in communication with network 124 via a communication device 125, which may be a cell phone, computer, pad device or any other device capable of communicating over network 124. The user 144 has a credit card 104 that is associated with a financial institution 126.

As further described below, embodiments protect user 144 from fraudulent transactions with their credit card 104 or any other transactions involving a physical token or card such as a driver's license, debit card, school ID, business ID, etc. In an embodiment, a credit card terminal 106 captures and reads data off a credit card 104's interaction with interaction terminal 108. The credit card terminal 106 transmits the data to controller 112 wherein upon receipt of the data, the controller 112 instructs camera 110 to capture media of the user who interacted the credit card 104 with the credit card terminal 106. Upon receipt of the captured media from camera 110, the controller 112 then, transmits the captured media and transactional information to a financial institution for security measures. The financial institution 126 receives the captured media and transactional information and retrieves data associated with the credit card from the transactional information. Then a user 144's profile associated with the data is retrieved from user profiles database 140. The financial institution 126 compares the captured media of the user who interacted credit card 104 with credit card terminal 106 to the profile image of user 144 retrieved from user profiles database 140. The results of the comparison are formulated in a message which is transmitted to controller 112 to determine if the transaction should be authorized, or further appropriate action should be taken.

In an embodiment, user 144 may set up security preferences with financial institution 126 regarding their credit card 104. The security preferences may be stored in user profiles database 140, according to an embodiment. In an example embodiment, user 144's preferences may set the frequency at which financial institution 126 performs facial recognition comparisons on their transactions and the frequency at which the financial institution 126 notifies user 144 of the facial recognition results. Due to the fact that facial recognition software 138 may require significant resources on financial institution 126's utilization of CPU 132 and bandwidth to transmit the results, financial institution 126 may require a monthly or other payment service from user 144, according to an embodiment. In an embodiment, the monthly payment amount directly relates to the frequency of utilizing facial recognition software 138 for transactions. In an alternative embodiment, the monthly payment amount directly relates to the frequency of notification results of the facial recognition software 138. In a further embodiment, the monthly payment amount directly relates to both the frequency of utilizing facial recognition software 138 and the frequency of notifying user 144 of the results of facial recognition software 138. For example, if user 144 pays a monthly premium amount to the financial institution 126, the financial institution 126 will perform facial recognition for every transaction performed on credit card 104 and notify the user 144 of the result. User 144 who pays substantially less than the premium amount will have substantially less facial recognition processing and notification performed, according to an embodiment. In an example embodiment, user 144 may pay a one-time fee to the financial institution 126 to perform facial recognition processing for one transaction a month and notify user 144 of the results. In an embodiment, user 144 does not pay for this service and will not have any facial recognition processing performed on their transactions and therefore, no notification of the facial recognition processing results.

In an example embodiment, user 144 may set preferences to be notified of a transaction along with facial recognition processing results if credit card 104 is used outside of user 144's home area or any other defined area, such as but not limited to outside user 144's area code. Other preferences may include if credit card 104 is interacted with the credit card terminal 106 for a transaction outside a particular time of day, according to an embodiment. In another embodiment, the user 144 may set a preference to send a report to law enforcement authorities 146 automatically if the results of the facial recognition processing are found to be a mismatch. Further explained below are how the security measures are performed.

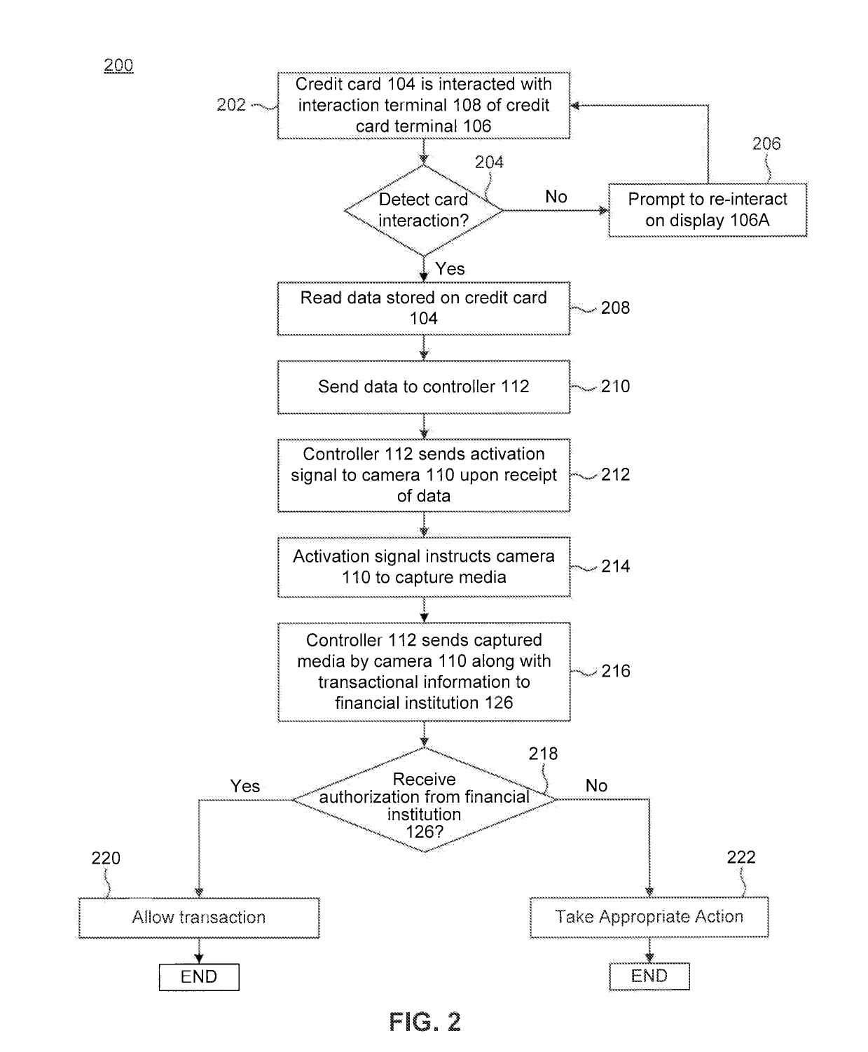

FIG. 2 is a method illustrating a process of capturing and preventing credit card fraud at a credit card terminal, according to an example embodiment.

In step 202, credit card terminal 106 may capture the credit card 104's interaction with interaction terminal 108, according to an example embodiment.

In step 204, credit card terminal 106 verifies the detection of the credit card 104's interaction, according to an example embodiment. If the credit card terminal 106 did not detect the interaction, then in step 206, credit card terminal 106 prompts to re-interact the credit card 104 with the credit card terminal 106 through the digital signature display line 106A. Otherwise, in step 208, credit card terminal 106 reads the data stored on the credit card 104. In an example embodiment, the data stored on credit card 104 may include the card holder's name, the card's account number, the expiration date and the card verification value (CVV).

In step 210, credit card terminal 106 transmits the data read off credit card 104 to controller 112, according to an example embodiment. In step 212, upon receipt of the data at the controller 112, the controller 112 transmits an activation signal to camera 110. In an embodiment, the activation signal may comprise a positive supply voltage or negative supply voltage. In an alternative embodiment, the activation signal may include a positive or negative voltage supply encoded with instructions to instruct camera 110 on how to capture the media. The instructions encoded in the positive supply voltage or negative supply voltage may be encoded via Manchester encoding, non-return to zero encoding, return to zero encoding or any type of data encoding techniques known to a person skilled in the art. The controller 112's firmware may be programmed to configure the selection of the footage or the photograph, and if footage, for a pre-determined amount of time. The controller 112's firmware encodes the instructions into the activation signal before transmitting to camera 110.

In an alternative embodiment, activation signal may be generated upon occurrence of another event such as detection of an interaction with credit card terminal 106. Other embodiments for generating activation signal exist, for example, activation signal may be generated when a user is detected in proximity to credit card terminal 106 using motion detection, for example.

In step 214, upon receipt of the activation signal at the camera 110, the activation signal instructs the camera 110 to capture media, according to an embodiment. Media may include footage for a pre-determined amount of time or a photograph, as mentioned above in step 212. In an embodiment, camera 110 decodes the activation signal to determine if encoded data exists. If the encoded data exists, the encoded data will instruct the camera 110 how to capture the media. Otherwise, the camera 110 will default to capturing a photograph, according to an embodiment. The camera 110 remains on while connected to credit card terminal 106, according to an embodiment. Once the media is captured, camera 110 transmits the media back to controller 112. In an alternative embodiment, upon receipt of the activation signal, camera 110 turns on, captures the media, transmits the media to controller 112 and shuts off

In step 216, controller 112 receives the captured media from the camera 110 and transmits the captured media along with transactional information to financial institution 126, according to an embodiment. In an embodiment, the transactional information includes the data read from the credit card 104 along with the purchase information. The purchase information may include but is not limited to the purchased items, the total cost of the transaction, and the cost of each individual purchase item in the transaction and the address of where the transaction occurred. The captured media and transactional information is transferred to the router 120 and processor 122 from the controller 112, according to an embodiment. In conjunction, the router 120 and processor 122 convert the captured media and transactional information into IP packets, according to an embodiment. The IP packets are then transmitted to financial institution 126 over network 124 using router 120, according to an embodiment.

In step 218, controller 112 waits for a response message from financial institution 126, according to an embodiment. The transaction initiated in step 202 is still pending at this point in the process. When the controller 112 receives the response message from the financial institution 126, the controller 112 determines the message type.

In step 220, if the message type is an authorization message, then the transaction is allowed, according to an embodiment. Alternatively, in step 222, if the message type is a non-authorization message, then the transaction is not allowed, according to an embodiment. Further appropriate action is taken at this point. For example, in an embodiment, retail store 102 may receive a message with the non-authorization message from the financial institution 126 to notify the law enforcement authorities 146 of a fraudulent credit card transaction according to user 144's preferences. In an alternative embodiment, retail store 102 may receive a message with the non-authorization message from the financial institution 126 notifying of insufficient funds in the account. In a further embodiment, retail store 102 may receive the non-authorization message without a separate message from the financial institution 126 and may decide to take its own further actions based on preferences of retail store 102.

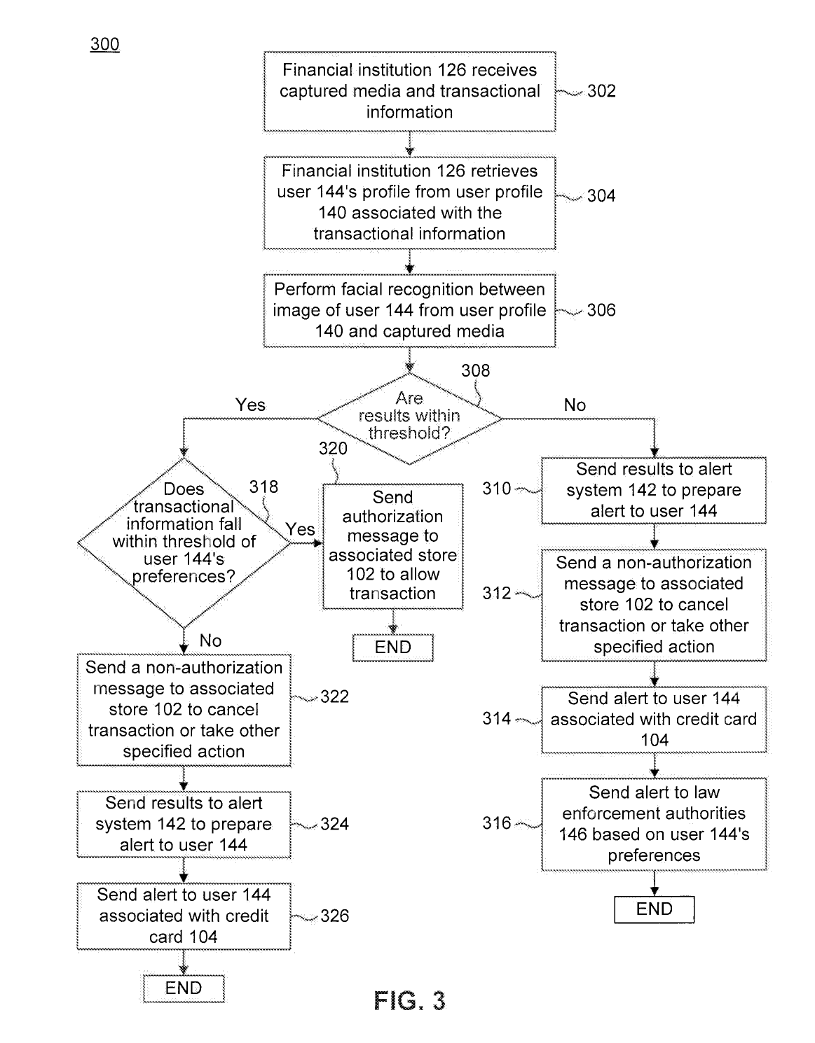

FIG. 3 is a method illustrating a process of capturing and preventing credit card fraud prevention at a financial institution, according to an example embodiment.

In step 302, financial institution 126 receives captured media and transactional information from controller 112, according to an example embodiment. The transactional information and captured media is received in the form of IP packets. According to an embodiment, NIC 128 processes the IP packets and CPU 132 retrieves the transactional information and captured media from the transmitted IP packets.

In step 304, CPU 132 parses the transactional information to retrieve the data from the credit card 104, according to an embodiment. As mentioned above, the data from the credit card 104 holds specific information pertaining to the credit card 104 including the card holder's name, the card's account number, the expiration date and the CVV. The CPU 132 retrieves the credit card holder's name and account, number, according to an embodiment. The CPU 132 then accesses user 144's profile in user profiles database 140 using credit card holder's name and account number as an index, according to an embodiment. User 144's profile maintains a headshot photograph of user 144, contact information of user 144 and their credit card information, according to an embodiment.

In step 306, CPU 132 passes the headshot photograph of user 144 and the captured media received from the controller 112 to facial recognition software 138, according to an embodiment. The facial recognition software 138 compares the headshot photograph of user 144 to the headshot found in the captured media, according to an embodiment. The facial recognition software 138 may use a plurality of software algorithms to compare the two headshots, according to an embodiment. For example, facial recognition software 138 may use Principal Component Analysis, Elastic Matching using the Fisherface algorithm and the Hidden Markov model, to name a few. Further, it would be understood by a person skilled in the art that the facial recognition software 138 may not be limited to the above mentioned algorithms. In other embodiments, facial recognition software 138 may use different algorithms for comparison.

In step 308, the facial recognition software 138 provides the results of the facial recognition process from step 306 to CPU 132 for determination of likelihood match via comparison to a threshold, according to an example embodiment. According to an embodiment, CPU 132 receives results of the facial recognition software 138's computations to establish the likelihood that the faces between the headshot found in the captured media received from the controller 112 and the headshot photograph of user 144 match or are the same person. A similarity score is computed based on the results of the facial recognition software 138's computation, according to an embodiment. The similarity score is compared to a threshold that determines if the two faces are the same or are different. In an example embodiment, the threshold may be such that the difference does not differ by more than two standard deviations.

In step 310, CPU 132 sends the mismatching results to alert system 142 based on the results of step 308, according to an example embodiment. The implications of dissimilar faces mean a fraudulent transaction has occurred. The alert system 142 prepares a report to user 144 with the results from, steps 306 and 308, captured media and the transactional information from step 302, according to an embodiment. The report is created in a manner to inform user 144 that a fraudulent transaction occurred showing a detailed description of the captured media by camera 110 and the transactional information received from controller 112, according to an embodiment. This report gives user 144 a full disclosure of the fraudulent credit card activity.

In step 312, the CPU 132 generates and transmits a non-authorization message to associated retail store 102 to cancel the transaction, according to an example embodiment. In an embodiment, a separate message may be transmitted with the non-authorization message to instruct associated retail store 102 to take further action. The non-authorization message informs the retail store 102 that a fraudulent transaction has occurred as a result of the facial recognition processing from step 306. In an embodiment, the separate message is based on the preferences set by user 144 stored in user profiles database 140. For example, user 144 may set a preference for the financial institution 126 to instruct retail store 102 to immediately contact law enforcement authorities 146. In a further example, user 144 may set a preference with the financial institution 126 to immediately freeze all activity on credit card 104.

In step 314, the alert report generated in step 310 by alert system 142 is transmitted to user 144 associated with credit card 104, according to an example embodiment. The alert report is transmitted to user 144 over network 124. According to an embodiment, user 144 may receive the alert report via email, text message, letter delivery, or any form of communication. User 144 may set preferences with the financial institution 126 as to how they prefer to receive alert reports.

In step 316, CPU 132 transmits alert report generated in step 310 to law enforcement authorities 146, according to an example embodiment. In an embodiment, user 144 may set another preference with financial institution 126 when sending an alert report to law enforcement authorities 146. For example, user 144 may set a preference to have the financial institution 126 automatically send an alert report to law enforcement authorities 146 every time a fraudulent transaction is detected. In alternative embodiment, user 144 may set a preference to review the alert report from the financial institution 126 and decide whether to inform law enforcement authorities 146. The preferences stored in user profiles database 140 gives the user 144 the flexibility to individual handle security preferences on his/her own personal account within the confines of financial institution 126, according to an embodiment.

If the facial recognition software 138 found the results of step 308 to be similar and the two faces match, then in step 318, CPU 132 verifies the transactional information is within threshold of user 144's preferences, according to an example embodiment. For example, CPU 132 may verify if sufficient funds are available for the purchase in the transactional information. In another embodiment, CPU 132 may verify the purchase in the transactional information resides in the area defined by user 144 in his or her preferences. In a further embodiment, CPU 132 may question the validity of a transaction if the purchase from the transactional information seems farfetched, such as hundreds of dollars spent at a fast food restaurant, per example.

If step 318 verifies the transactional information does fall within the threshold of user 144's preferences, then in step 320, CPU 132 transmits an authorization message to associated retail store 102, according to an example embodiment. In an embodiment, the authorization message allows the transaction at associated retail store 102.

Alternatively, if the transactional information does not fall within threshold of user 144's preferences, then in step 322, CPU 132 transmits a non-authorization message to associated retail store 102, according to an example embodiment. In an embodiment, the non-authorization message cancels the transaction and/or instructs the retail store 102 to take further appropriate action. For example, financial institution 126 may instruct retail store 102 to display a message of insufficient funds on credit card 104 to the display line 106A of credit card terminal 106.

In step 324, similar to step 310, CPU 132 sends the results of step 318 to alert system 142, according to an example embodiment. The alert system 142 prepares a report to user 144 with the results from step 308 including captured media and the transactional information from step 302, according to an embodiment. The report is created in a manner to inform user 144 that the transaction does not fall within the threshold of user 144's preferences, according to an embodiment. Further, the report shows a detailed description of the captured media by camera 110 and the transactional information received from controller 112, according to an embodiment. Even if the captured media shows user 144 to be the same person, it may be beneficial to user 144 to see the captured media and determine from visual inspection, if the results from the facial recognition, process 306 were correct or not, according to an embodiment.

In step 326, similar to step 314, the alert report generated in step 324 by alert system 142 is transmitted to user 144 associated with credit card 104, according to an example embodiment. In an embodiment, if the results of the facial recognition process 306 were deemed incorrect by user 144's way of visual inspection, user 144 has the functional ability to report back, to financial institution 126 that a different user than user 144 used credit card 104 for a transaction. The functional ability is performed via email, phone call, text message, access to a financial institution 126's website or any other means of communication, according to an embodiment. This will trigger financial institution 126 to automatically send an alert report to law enforcement authorities 146, according to an embodiment. Simultaneously, an employee of financial institution 126 may review user 144's denial of the facial recognition process to determine the validity of the rejection, according to an embodiment. If the employee agrees with user 144's rejection, then the employee may use the results to update facial recognition software 138, according to an embodiment. Updates to facial recognition software 138 may be used to further advance its accuracy and precision, according to an embodiment. As an example, updates may include storing a library of template faces to tune the efficiency of facial recognition software 138. This will be beneficial to credit card security system 100 by improving the facial recognition software 138's ability to detect fraudulent users.

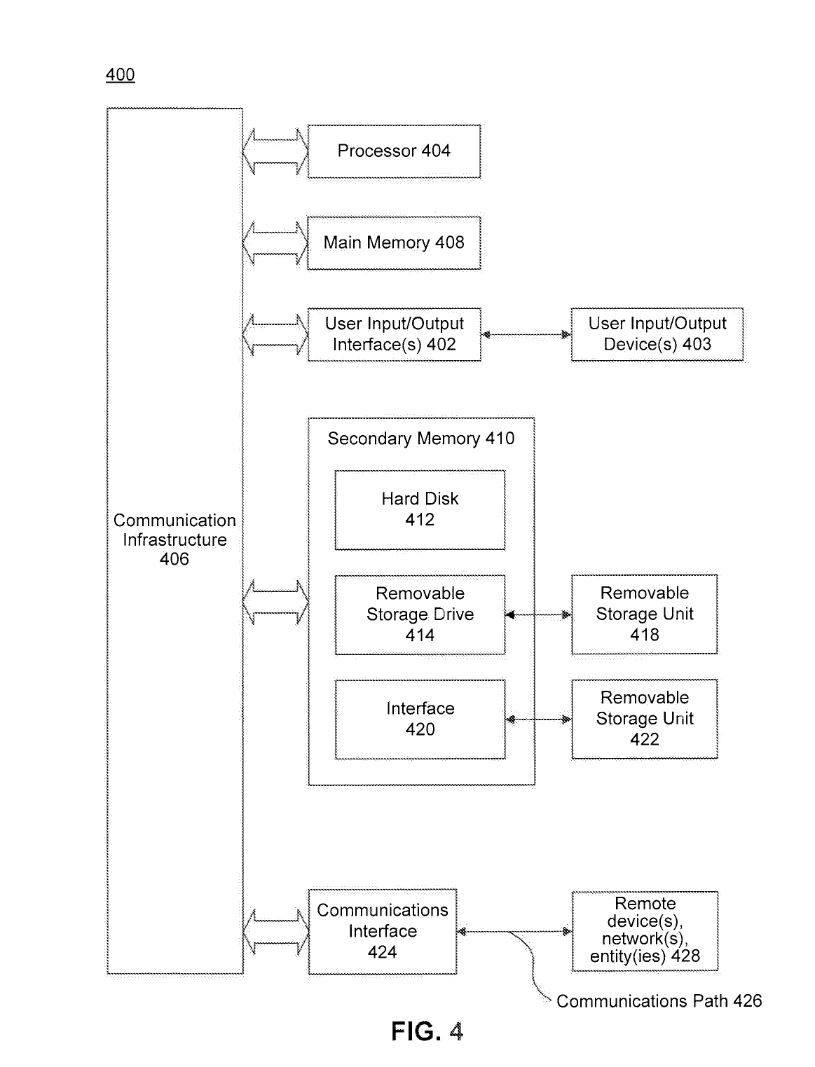

Various embodiments can be implemented, for example, using one or more well-known computer systems, such as computer system 400 shown in FIG. 4. Computer system 400 can be any well-known computer capable of performing the functions described herein, such as computers available from International Business Machines, Apple, Sun, HP, Dell, Sony, Toshiba, etc.

Computer system 400 includes one or more processors (also called central processing units, or CPUs), such as a processor 404. Processor 404 is connected to a communication infrastructure or bus 406.

Computer system 400 also includes user input/output device(s) 403, such as monitors, keyboards, pointing devices, etc., which communicate with communication infrastructure 406 through user input/output interface(s) 402.

Computer system 400 also includes a main or primary memory 408, such as random access memory (RAM). Main memory 408 may include one or more levels of cache. Main memory 408 has stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 includes a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 reads from and/or writes to removable storage unit 418 in a well-known manner.

According to an exemplary embodiment, secondary memory410 may include other means, instrumentalities or other approaches for allowing computer programs and/or other instructions and/or data to be accessed by computer system 400. Such means, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 enables computer system 400 to communicate and interact with any combination of remote devices, remote networks, remote entities, etc. (individually and collectively referenced by reference number 428). For example, communication interface 424 may allow computer system 400 to communicate with remote devices 428 over communications path 426, which may be wired and/or wireless, and which may include any combination of LANs, WANs, the Internet, etc. Control logic and/or data may be transmitted to and from computer system 400 via communication path 426.

In an embodiment, a tangible apparatus or article of manufacture comprising a tangible computer useable or readable medium having control logic (software) stored thereon is also referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), causes such data processing devices to operate as described herein.

Based on the teachings contained in this disclosure, it will be apparent to persons skilled in the relevant art(s) how to make and use the invention using data processing devices, computer systems and/or computer architectures other than that shown in FIG. 4. In particular, embodiments may operate with software, hardware, and/or operating system implementations other than those described herein.

It is to be appreciated that the Detailed Description section, and not the Summary and Abstract sections (if any), is intended to be used to interpret the claims. The Summary and Abstract sections (if any) may set forth one or more but not all exemplary embodiments of the invention as contemplated by the inventor(s), and thus, are not intended to limit the invention or the appended claims in any way.

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the invention should not be limited by any of the above-described exemplary embodiments, but should he defined only in accordance with the following claims and their equivalents.

What is claimed is:

1. A system, comprising:
a processor;
a router coupled to the processor;
a terminal coupled to the processor and the router and operable to accept input from a card associated with an authorized user;
a camera proximate to the terminal, the camera operable to capture media of a person located proximate to the terminal; and
an authentication module coupled to the processor and the router via a network, wherein the authentication module comprising a facial recognition module;
wherein the media is transferred to the authentication module, and wherein the authentication module uses the facial recognition module to determine if the person is the authorized user.

2. A method of fraud prevention, comprising:
capturing, an interaction of a card associated with an authorized user with a card terminal;
reading data stored on the card;
transmitting the data to a controller;
transmitting an activation signal to a camera, upon occurrence of an event;
upon receipt of the activation signal, capturing media by the camera of a user who interacted the card with the credit card terminal;
receiving the captured media from the camera;
transmitting the captured media and transactional information to a financial institution for security measures; and
receiving a type of message from the financial institution regarding the security measures, wherein the type is an authorization or a non-authorization message.

3. The method of claim 2, wherein the activation signal is encoded with instructions.

4. The method of claim 3, wherein the encoded instructions instructs the camera how to capture the media.

5. The method of claim 4, wherein the captured media includes at least one of footage of a predetermined amount of time and a photograph.

6. The method of claim 2, wherein the event is at least one of motion detection and the interaction of a card.

7. The method of claim 2, wherein the interaction of a card with the credit card terminal includes at least one of swiping, inserting, tapping, or waving, or any combination thereof.

8. A method of fraud prevention, comprising:
receiving captured media of a card user and transactional information from a controller;
retrieving data associated with a card from the transactional information;
retrieving a profile of an authorized user associated with the data;
comparing the card user and the authorized user from the profile to determine if they match;
transmitting a report to the authorized user associated with the profile indicating a result of the comparison with the transactional information;
transmitting a type of message to the controller, wherein the type is an authorization or a non-authorization message; and
transmitting the report with the transactional information to law enforcement authorities.

9. The method of claim 8, wherein the transactional information comprises the data read from the card and transaction information.

10. The method of claim 8, wherein a subset of the data retrieved from the transactional information is used as an index to retrieve a profile of the user associated with the data;

11. The method of claim 8, wherein the comparing the card user and the authorized user from the profile is performed utilizing facial recognition software.

12. The method of claim 11, wherein a similarity score is computed based on the results of the facial recognition software.

13. The method of claim 12, wherein the similarity score is compared to a threshold to determine if the card user and the, authorized user from the profile are a match.

14. The method of claim 8, wherein the type of the message is determined based on the results of the comparison between the card user and the authorized user from the profile.

15. A controller processor device, comprising:
a processor operable to:
receive data stored on a card;
transmit an activation signal to a camera to capture media of a user who interacted the card with a card terminal upon occurrence of an event;
receive the captured media from the camera;
transmit the captured media and transactional information to a financial institution using a router for security measures; and
receive a type of message from the financial institution regarding the security measures, wherein the type is an authorization or a non-authorization message.

16. The controller processor device of claim 15, wherein the activation signal is encoded with instructions.

17. The controller processor device of claim 16, wherein e encoded instructions instructs the camera how to capture the media.

18. The controller processor device of claim 17, wherein the captured media includes at least one of footage of a predetermined amount of time and a photograph.

19. The controller processor device of claim 15, wherein the event is at least one of motion detection and the interaction of a card.

20. The controller processor device of claim 15, wherein the non-authorization message includes a separate message specifying further action to take.

21. The controller processor device of claim 20, wherein the separate message instruction of further appropriate action comprises contacting the law enforcement authorities.
